(19) United States
(12) Patent Application Publication
(10) Pub. No.: US 2016/0340806 A1
(43) Pub. Date: Nov. 24, 2016

(54) Drive Device for a Textile Machine

(71) Applicant: Maschinenfabrik Rieter AG, Winterthur (CH)

(72) Inventors: Felix Keller, Wilen b. Wil (CH); Willi Schläpfer, Fehraltorf (CH)

(21) Appl. No.: 15/149,797

(22) Filed: May 9, 2016

(30) Foreign Application Priority Data
May 21, 2015 (CH) 00705/15

(51) Int. Cl. D01H 1/22; D01G 27/02; F16H 37/02

(52) U.S. Cl. CPC D01H 1/22; F16H 37/02; D01G 27/02

(57) ABSTRACT

The invention relates to a drive device of a preparation machine (1) for producing lap rolls (W), comprising a double-shaft motor (M), the first output shaft (W1) of which extends into a gearbox (G), which is connected via drive means (G1, G2) to a winding unit (WA) and to calender rolls (A1-A4) installed upstream of the winding unit, and the second output shaft (W2) of the double-shaft motor (M) is connected via at least a first belt drive (B1), which is provided with a drive belt (E1) guided via pulleys (R1, R2), to an intermediate shaft of a feed table (T), which is connected via further drive means (G3) to at least one delivery roller (20) of a drafting system (SW), which delivery roller is installed with parallel spacing from the intermediate shaft. In order to achieve a low-cost drive solution, it is proposed that at least one further drive means (B2) is provided between the second output shaft (W2) of the double-shaft motor (M) and a first pulley (R1) of the first belt drive (B1), which pulley is fastened on a shaft (17) rotatably mounted with parallel spacing from the second output shaft (B2), which drive means reverses the direction of rotation of the second output shaft (W2) to the first pulley (R1), and the gearbox (G) has an even number of gear stages (SG).

A drive device of a preparation machine for producing lap rolls (W), comprising a double-shaft motor, the first output shaft of which extends into a gearbox, which is connected via drive means to a winding unit and to calender rolls installed upstream of the winding unit, and the second output shaft of the double-shaft motor is connected via at least a first belt drive, which is provided with a drive belt guided via pulleys, to an intermediate shaft of a feed table, which is connected via further drive means to at least one delivery roller of a drafting system, which delivery roller is installed with parallel spacing from the intermediate shaft.

The use of such double-shaft motors in textile machines is already known. For example, a double-shaft motor is shown in DE 10 2013 103 177 A1, wherein a first output shaft drives units that are installed upstream of a drafting system, while the second output shaft drives the rollers of the drafting system.

Embodiments are also known, in which a mechanical gearbox unit is directly fastened on one side of the double-shaft motor, into which gearbox unit one of the output shafts of the double-shaft motor extends. By means of the available gear stages, the output speed of the double-shaft motor is correspondingly modulated and adapted to the downstream units to be driven. Depending on the number of gear stages, the direction of rotation of the output shaft of the double-shaft motor is retained or reversed.

Preparation machines for producing a lap roll for the downstream processing on a comber are already known, wherein double-shaft motors are used that have a gearbox unit, which has an uneven number of gear stages, in the area of one of the output shafts. As a result, there are different directions of rotation between a first output shaft of the double-shaft motor and an output shaft of a gearbox unit fastened on the double-shaft motor, into which gearbox unit the second output shaft of the double-shaft motor extends.

The disadvantage of this arrangement is that such double-shaft motors comprising a flange-mounted gearbox having an uneven number (e.g., three) of gear stages have a large design and are designed as special motors, which are relatively expensive. The only advantage of using such motors is that the drive of an intermediate shaft on the feed table for the lap-forming device can be carried out using a simple belt drive.

It is therefore an object of the invention to propose a drive device for a preparation machine for producing lap rolls, which drive device eliminates the aforementioned disadvantages and permits the use of standardized, low-cost, series-production motors.

In order to achieve the object, it is therefore proposed that at least one further drive means is provided between the second output shaft of the double-shaft motor and a first pulley of the first belt drive, which pulley is fastened on a shaft rotatably mounted with parallel spacing from the second output shaft, which drive means reverses the direction of rotation of the second output shaft to the first pulley, and the gearbox has an even number of gear stages.

The second pulley of the first belt drive is fastened directly on the intermediate shaft. Preferably two gear stages of the gearbox can be provided. Therefore, the gearbox can be designed so as to be small, compact, and having high stability.

As a result, the output shaft of the gearbox flange-mounted on the double-shaft motor has the same direction of rotation as the second output shaft of the double-shaft motor, which extends into the gearbox. The first output shaft of the double-shaft motor, which is located on the opposite end face of the motor, also has the same direction of rotation as the output shaft of the gearbox. As a result of the proposed use of a further drive means between the first output shaft of the double-shaft motor and a first pulley of a first belt drive, the direction of rotation of the first output shaft is reversed during the drive transmission to the first pulley, and so the direction of rotation of the downstream intermediate shaft of the feed table is in the required form. It is therefore possible to keep the drive device of the feed table unchanged.

In addition, it is proposed that the at least further drive means consists of a double-sided toothed belt drive, the double-sided toothed belt of which, via its inner toothing, wraps partially around a first toothed pulley, which is connected to the second output shaft, and, via its outer toothing, rests on a portion of the periphery of a second toothed pulley, which is coaxially installed on a shaft of the first pulley of the first belt drive, and a belt tensioner is rotatably mounted on an axle with radial spacing from the shaft of the first pulley, wherein the inner toothing of the double-sided toothed belt wraps partially around the belt tensioner.

As a result of the further proposal to install a disengagable clutch on the shaft of the first pulley, via which the first pulley can be drivably connected to the second toothed pulley, an easy separation between the double-shaft motor and the driven units of the feed table is made possible. Such a separation is necessary, for example, when a lap ejection is carried out. This means that the first pulley is non-rotatably connected via the clutch to the rotatably mounted shaft on which the second toothed pulley of the double-sided toothed belt drive is non-rotatably installed.

Preferably, the clutch is a pneumatic clutch, to which a sensor for monitoring the operating position is assigned. An unintentional start-up of the lap-forming device can therefore be easily prevented when the drive to the feed table is still interrupted. The double-sided toothed belt can rest on the second toothed pulley via its pulling side or its pulled side.

In order to permit the drive to the calender rolls to be interrupted when the finished lap roll is ejected, it is further proposed that a pneumatic clutch, to which a sensor for monitoring its operating position is assigned, is provided between the gear stage of the second shaft of the motor and the calender rolls.

This is necessary, in particular, for the tear-off of the lap web at the end of the finished lap roll.

For the purpose of simple preassembly and installation in the machine frame of the preparation machine, it is further proposed that the shaft of the first pulley, with the second toothed pulley installed thereon, and the axle of the belt tensioner are installed on a bearing element, which is removably fastened on the machine frame.

In order to permit the double-sided toothed belt to be tensioned, it is proposed that the axle of the belt tensioner is installed on the bearing element so as to be displaceable transversely to its longitudinal direction.

Preferably, the winding unit consists of a circulating belt guided over rollers, wherein at least one of the rollers is drivably connected to the double-shaft motor.

Moreover, it is proposed that the calender rolls, which are rotatably mounted on the feed table, are also connected via drive means to the intermediate shaft (ZW).

These calender rolls are each installed downstream of the available drafting system units and are used not only for calendering but also for supporting the transport of the lap web on the feed table.

Further advantages are shown and described with reference to exemplary embodiments that follow.

In the drawings:

FIG. 1 shows a schematic side view of a known embodiment of a drive device of a lap-forming preparation machine,

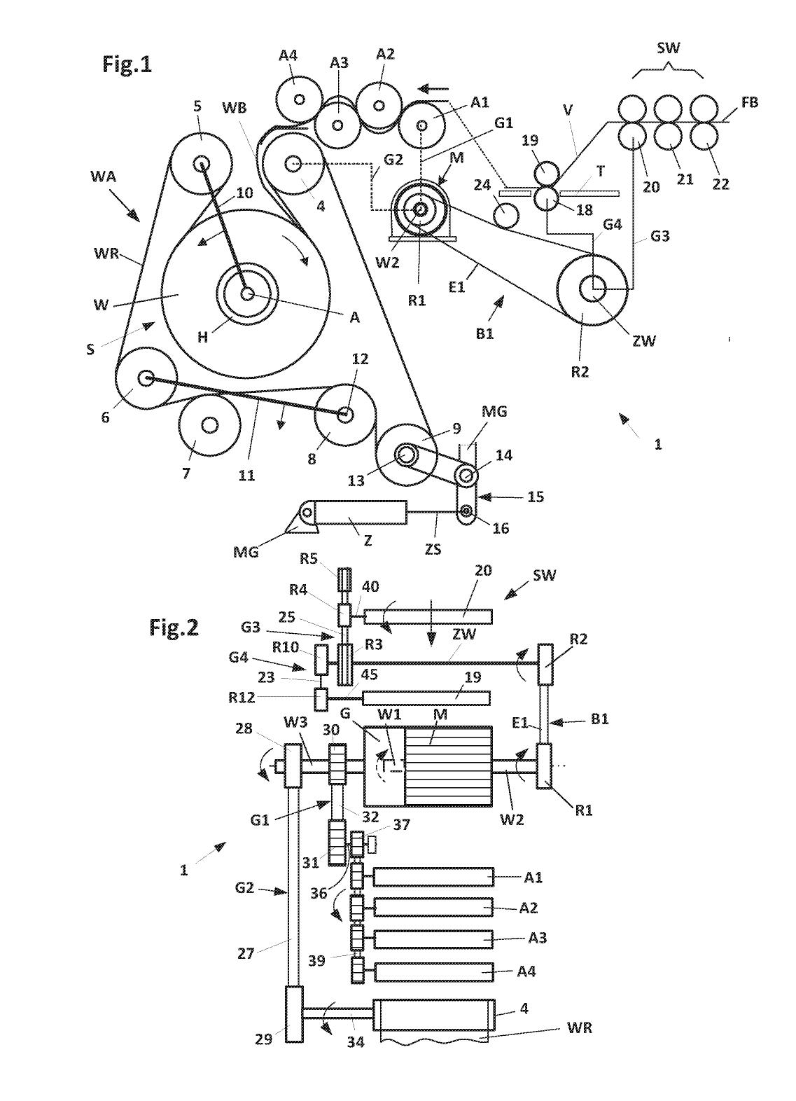

FIG. 2 shows a schematic top view (partial view) according to FIG. 1,

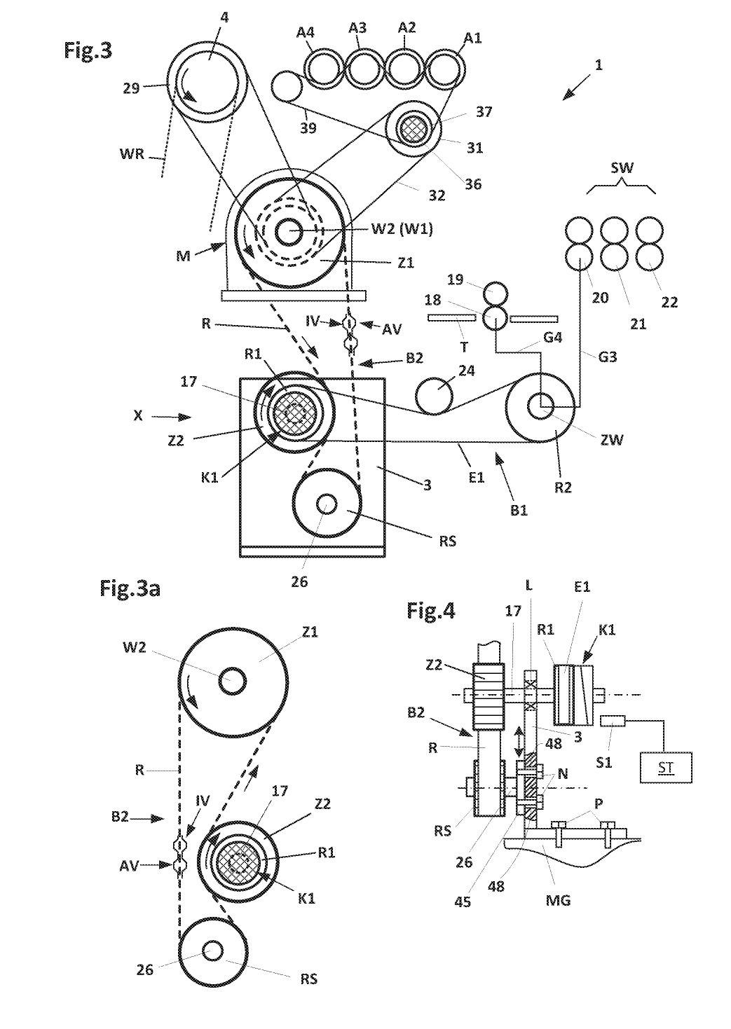

FIG. 3 shows a schematic side view according to FIG. 1 comprising an additional drive means proposed according to the invention,

FIG. 3a shows a embodiment variant according to FIG. 3,

FIG. 4 shows a view X (partial view) according to FIG. 3, and

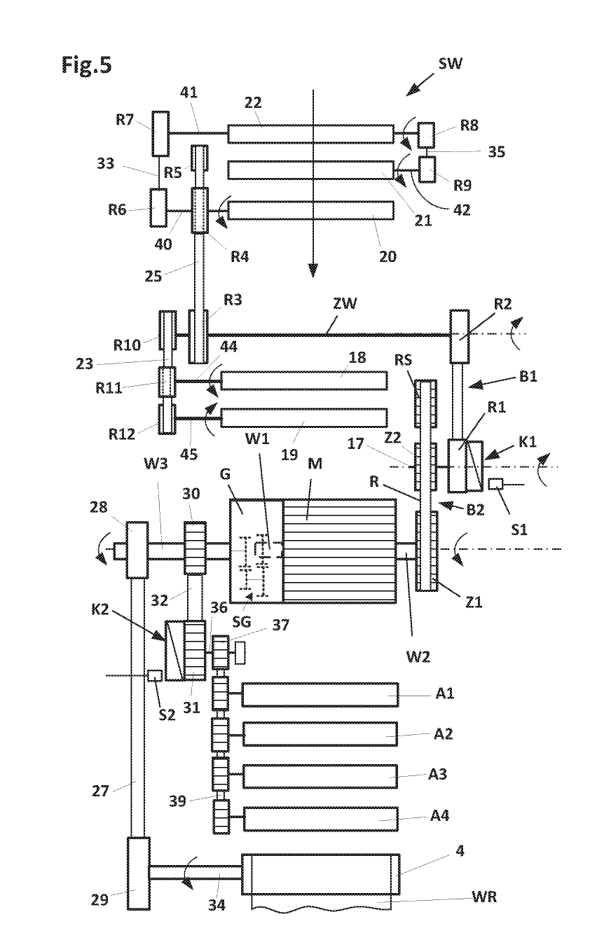

FIG. 5 shows a schematic top view according to FIG. 3.

FIG. 1 shows a schematic side view of a preparation machine 1 for forming lap rolls W (referred to simply as “laps”), which are required for the further processing on downstream combers. As is already known from the previously published document EP 1 675 976 B1, in a winding unit WA, a lap W is produced in a loop S of a circulating belt WR by winding a lap web WB onto a rotatably mounted tube H. In this connection, the belt WR is guided over guide rollers 4 through 9, wherein the guide roller 9 is designed as a pivotable belt tensioner. The guide roller 9, which is rotatably mounted on an axle 13, is mounted so as to be pivotable, by means of a double pivot arm 15, about a pivot axle 14 fastened on the machine frame MG. A cylinder rod ZS of a cylinder Z, which is supported on the machine frame MG, is installed at the other end of the double pivot arm 15 by means of an axle 16. The belt WR is tensioned by means of the belt tensioner 9 (guide roller) during the winding up process and is held against the increasing outer circumference of the lap W.

In order to eject the finished lap W, the guide rollers 5 and 6 are disposed so as to be pivotable about the axis A and 12 via the arm 10 and 11 respectively. Before the lap web WB is introduced into the loop S of the lap-forming device WA, it is guided through a number of calender rolls A1 through A4, which are disposed one behind the other, wherein said lap web is compressed and prepared for the lap-forming process. A schematically indicated feed table T is installed upstream of the lap-forming device WA and the calender rolls A1-A4. Shown above the feed table T is one of at least two drafting systems SW, to which a plurality of slivers FB for the drawing-in process are fed. The particular drafting system SW comprises roller pairs disposed one behind the other with spacing, the bottom rollers of which (delivery roller 20, middle roller 21, and feed roller 22) are driven. The drive of the delivery roller 20 is carried out by schematically indicated drive means G3, which are shown in greater detail in FIG. 2. The drive for the rollers 21 and 22 is carried out by way of the delivery roller 20 via further drive means, which are not shown in greater detail.

The pressure rollers installed above these rollers are driven by the bottom rollers by means of friction.

The slivers FB are drawn from non-illustrated cans, which are provided on the feed table T, and are fed to the particular drafting system SW via corresponding guides. The fibrous webs V formed at the drafting systems SW are placed on top of one another on the feed table T and are fed to the calender rolls A1-A4. This process is supported by calender rolls 18, 19 (also referred to as table calenders), which are rotatably mounted and driven in the area of the feed table T. The drive of the calendar rolls 18, 19 is carried out by means of schematically illustrated drive means G4, which are shown, in part, in FIG. 2 for the calendar roll 19.

As is clear from FIG. 2, in the present example, the drive of the different units of the preparation machine 1 is carried out by a double-shaft motor M (referred to simply as “motor”). A first output shaft W1 of the motor M extends into a gearbox G, which, in the present example, is equipped with an uneven number of gear stages (e.g., three gear stages). That means the direction of rotation (as schematically indicated by an arrow) of the output shaft W1, which forms an input shaft in the gearbox G, is reversed or turned relative to the output shaft W3 of the gearbox G. In the present example, the gearbox G has an uneven number (e.g., three) of gear stages. The drive of the guide roller 4 and, therefore, of the belt WR of the lap-forming device WA and the drive of the calender rolls A1-A4 is carried out by way of the output shaft W3 using corresponding drive means G1 and G2, respectively.

As is clear from FIG. 2, the drive of the guide roller 4 is carried out by means of a pulley 28, which is mounted on the output shaft W3 and is connected via a belt 27 to a pulley 29, which is mounted on a shaft 34 of the guide roller 4.

In addition, a toothed pulley 30 is fastened on the output shaft W3, which pulley is drivably connected to a toothed pulley 31 via a toothed belt 32.

The toothed pulley 31 is mounted on a rotatably mounted shaft 36, on which a further toothed pulley 37 is fastened. This toothed pulley 37 is drivably connected via a toothed belt 39 to further toothed pulleys, which are mounted on axles of the calendar rolls A1-A4. Reference is made to the published document DE-10323130B4 for further details of this drive guidance.

In the present example, the second output shaft W2 of the motor M has a direction of rotation (indicated by an arrow) that is opposite that of the output shaft W3. Therefore, the drive of an intermediate shaft ZW rotatably mounted in the area of the feed table T is carried out directly by means of a first belt drive B1. Initiating at a first pulley R1 mounted on the output shaft W2, the drive transmission to a second pulley R2, which is mounted on the intermediate shaft ZW, is carried out by means of a belt E1. A belt tensioner 24, by means of which the belt E1 is tensioned, is schematically indicated. Pulleys R3 and R10 are mounted on the intermediate shaft ZW at the opposite end. From the pulley R3, a belt 25 extends to a pulley R5. A pulley R4, which is partially wrapped around by the belt 25, rests on the outer side of the belt 25 (it can be, e.g., a double-sided toothed belt). The pulley R4 is mounted on an axle 40 of the delivery roller 20. The driver of the middle roller 21, which is not shown here, and the feed roller 22 can be carried out according to the exemplary embodiment according to FIG. 5. In addition, the drive of the calender roll 19, which is shown by way of example, is carried out via the pulley R10, which is connected via the belt 23 to the pulley R12, which is fastened on the axle 45 of the calender roll 19. The drive of the calender roll 18 can be carried out according to the exemplary embodiment according to FIG. 5.

FIG. 5 shows one exemplary embodiment according to the invention, wherein installed between the belt drive B1 and the output shaft W2 is an additional belt drive B2, by means of which a reversal of the direction of rotation of the output shaft W2 of the motor M is carried out relative to the shaft 17, on which the first pulley R1 of the first belt drive B1 is mounted. Due to this reversal of the direction of rotation, it is possible to design the gearbox G with an even number (e.g., two stages) of gear stages SG, and so the direction of rotation required for the downstream units (guide roller 4, calender rolls A1-A4) is present. Therefore, a double-shaft motor having a standard and common gearbox G can be used, which, on the one hand, is reasonably priced and, on the other hand, ensures a compact and stable design. The drive of the guide roller 4 for the belt WR of the winding unit WA and the drive of the calender rolls A1-A4 initiates at the shaft W3, as has already been described for the exemplary embodiment of FIG. 2. The only difference is the installation of a, e.g., pneumatic clutch K2 on the shaft 36, by means of which a fixed drive connection between the toothed pulley 31 and the shaft 36 can be established or interrupted. In this embodiment, the toothed pulley 31 is rotatably mounted on the shaft 31. A sensor S2, which is connected to the central control ST, is provided for monitoring the operating position of the clutch K2. The clutches K1 and K2 are used, in particular, for separating the drive means from the motor M in the area of the feed table T and the calender rolls A1-A4 when an ejection of a finished lap roll W is carried out. This means, in order to separate the end of the lap web of the finished lap from the fed lap web, only the guide roller 4 is driven, temporarily, while the other units are decoupled from the motor M via the disengaged clutches K1, K2. Further details regarding the lap ejection can be found in known prior publications and are not discussed further here.

The sensors S1 and S2 also have a monitoring function in respect of the operating state of the drive device. The intention thereof is to prevent a faulty start-up and stoppage of the drive device, which is monitored by the central control ST.

As is clear from FIG. 3, the additional belt drive R2 comprises a double-sided toothed belt R, which is driven by a toothed pulley Z1, which is fastened on the output shaft W2. In addition, the double-sided toothed belt R wraps partially around a belt tensioner R2, which is rotatably mounted on an axle 26 (FIG. 4) disposed with radial spacing from the output shaft W2. As is clear from the partial view in FIG. 4, the axle 26 is fastened on a plate 45, which is detachably fastened on a bearing element 3 using screws N. The bearing element 3, which is designed so as to be L-shaped, is fastened on the machine frame MG of the preparation machine 1 using screws. In order to tension the double-sided toothed belt R, the belt tensioner RS is mounted on the bearing element 3 so as to be displaceable parallel to the output shaft W2. To this end, slots 48 are provided in the bearing element 3, through which the screws N extend. After the screws N are loosened, the belt tensioner RS can be displaced along the bearing element, as indicated by a double arrow, in order to tension the belt R. Above the belt tensioner RS, a shaft 17 is rotatably mounted via the bearing L in the bearing element 3, on which shaft a toothed pulley Z2 is fastened at one end, which toothed pulley engages with a portion of its toothing into the outer toothing AV of the toothed belt R. In the example in FIG. 3, this engagement takes place in the area of the pulled portion of the toothed belt R, whereas, in the exemplary embodiment according to FIG. 3a, this engagement takes place in the area of the pulling portion of the toothed belt. Both variants are possible, wherein the force transmission of the embodiment according to FIG. 3a is somewhat better.

A clutch K1 (e.g., pneumatic) is installed at the other end of the shaft 17. The disengagable part of the clutch K1 is connected to the pulley R1, which is rotatably mounted on the shaft 17. This means the pulley R1 is fixedly connected to the shaft 17 when the clutch K1 is engaged. A sensor S1, which is connected to a control ST, is provided for monitoring the state (engaged or disengaged) of the clutch K1.

As a result of the mounting of the axle 26 and the shaft 17 on the bearing element 3, it is possible to design the bearing element 3 with the toothed pulley Z2, the belt tensioner RS, the clutch K1 having the sensor S1 and the pulley R1 as one assembly, which can be preassembled and then completely fastened in the machine frame MG.

The pulley R2 of the first belt drive B1 is driven by means of the belt E1. A displaceably mounted belt tensioner 24 is provided for tensioning the belt E1.

The pulley R2 is at one end of an intermediate shaft ZW, which is (not shown) rotatably mounted on a feed table T of the preparation machine 1. Pulleys R3 and R10 are non-rotatably mounted at the other end of the intermediate shaft ZW. A pulley R12, which is fastened on an axle 45 of a calender roll 19 rotatably mounted on the feed table T, is driven by the pulley R10 by means of a belt 23. A pulley R11 is held against the outer side of the belt 23 by means of a non-illustrated tensioning device. The calender roll 18 is driven in the direction of rotation opposite that of the calender roll 19, as is schematically indicated by arrows, by means of the pulley R11, which is fastened on an axle 44 of a rotatably mounted calender roll 18. Between the clamping point of the calender rolls 18, 19, the fibrous web V delivered by the drafting systems SW (typically two) is calendered on the feed table and is transported in the direction of the downstream calender rolls A1 through A4.

The pulleys R3 and R5 are drivably connected to the intermediate shaft ZW by means of a belt 25. In order maintain the required direction of rotation of the delivery roller 20 of the drafting system SW, which is shown by an arrow, a pulley R4, which rests on the outer side of the belt 25 with a suitable pressing force, is fastened on an axle 40 of the delivery roller 20. In order to prevent slip between the pulley R4 and the belt 25, it is possible to design the belt 25 as a double-sided toothed belt, wherein the pulleys R3, R4 and R5 would be designed as toothed pulleys.

A pulley R7, which is non-rotatably mounted on an axle 41 of a rotatably mounted feed roller 22 of the drafting system SW, is driven by the pulley R6, which is also non-rotatably mounted on the axle 40, by means of a belt 33. A pulley R8, by means of which the drive is transmitted to a pulley R9 by means of a belt 35, is fastened at the opposite end of the axle 41. The pulley R9 is non-rotatably seated on an axle 42 of a rotatably mounted middle roller 21 of the drafting system SW. The illustration of a further drafting system was omitted. The drive for a further drafting system can be carried out directly by the intermediate shaft ZW or by the axle 40 of the drafting system SW shown.

The drive device proposed according to the invention, in particular the additional drive means for reversing the direction of rotation between the second output shaft W2 of the double-shaft motor M and a first belt drive B1, which is connected to an intermediate shaft of the feed table T, results in a compact and simple drive device in which standard drive elements, such as a standard double-shaft motor having a gearbox unit with an even number of gears, can be used.

1. A drive device of a preparation machine (1) for producing lap rolls (W), comprising a double-shaft motor (M), the first output shaft (W1) of which extends into a gearbox (G), which is connected via drive means (G1, G2) to a winding unit (WA) and to calender rolls (A1-A4) installed upstream of the winding unit, and the second output shaft (W2) of the double-shaft motor (M) is connected via at least a first belt drive (B1), which is provided with a drive belt (E1) guided via pulleys (R1, R2), to an intermediate shaft of a feed table (T), which is connected via further drive means (G3) to at least one delivery roller (20) of a drafting system (SW), which delivery roller is installed with parallel spacing from the intermediate shaft,
characterized in that at least one further drive means (B2) is provided between the second output shaft (W2) of the double-shaft motor (M) and a first pulley (R1) of the first belt drive (B1), which pulley is fastened on a shaft (17) rotatably mounted with parallel spacing from the second output shaft (W2), which drive means reverses the direction of rotation of the second output shaft (W2) to the first pulley (R1), and the gearbox (G) has an even number of gear stages (SG).

2-13. (canceled)
